(19) United States
(12) Patent Application Publication
(10) Pub. No.: US 2006/0115783 A1
(43) Pub. Date: Jun. 1, 2006

(54) Apparatus and method for curing a light curable adhesive

(76) Inventor: Edwin C. McLaren, (US)

Correspondence Address: EMCH, SCHAFFER, SCHAUB & PORCELLO CO, P O BOX 916, ONE SEAGATE SUITE 1980, TOLEDO, OH, 43697, US

(21) Appl. No.: 11/290,181

(22) Filed: Nov. 29, 2005

Related U.S. Application Data
(60) Provisional application No. 60/632,582, filed on Dec. 1, 2004.

(51) Int. Cl. A61C 3/00

(52) U.S. Cl. 433/29; 433/215

(57) ABSTRACT

A method and device for directing ultra violet light for an ultra violet source for curing an adhesive composite.

### This application claims the benefit of U.S. provisional patent application serial No. 60/632,582 filed Dec. 1, 2004.

### BACKGROUND OF THE INVENTION

This invention relates to an apparatus in method for using ultra violet light to cure a composite adhesive. The composite adhesive is cured by subjecting the adhesive to the ultra violet light, which causes the adhesive to cure or harden. The composite adhesive is utilized to bond a material or surface to a substrate. This type of bonding has many applications but is particularly utilized in the dental industry to bond veneers, crowns and similar products to a tooth or other dental appliance.

In the bonding process, particularly as used in dentistry, the composite adhesive is applied to the material that is to be bonded to a tooth and also to the surface of the tooth. The material to be bonded is then positioned on the tooth and advanced against the tooth with sufficient force to form a good interface between the material and the tooth. The composite adhesive is usually forced from the interface between the tooth and the material as the material is positioned on the tooth. The flow of excess material from the interface acts as an indication that there is sufficient composite adhesive in the desired location to accomplish the bonding process. Once the material is properly positioned on the tooth ultra violet light is directed to the tooth to cure or harden the composite adhesive to complete the bonding process. The ultra violet light also contacts the excess composite adhesive that has been forced from the interface between the material and the tooth. Accordingly, the excess composite adhesive is also cured or hardened by the application of the ultra violet light.

The cured excess composite adhesive is not intended to remain in the mouth of the patient and must be removed to produce an aesthetically pleasing result. However, the excess composite adhesive has been cured by the ultra violet light and is now bonded to the surrounding teeth or dental structure in the mouth of the patient. The cured excess composite adhesive is difficult to remove and frequently requires the dentist to spend a significant amount of time in the removal process. The adhesive is usually clear, difficult to see in the patients mouth and difficult to remove completely. The removal process for the excess composite adhesive adds cost to the dental procedure and can also be a significant inconvenience for the patient.

### SUMMARY OF THE INVENTION

In accordance with the invention there is provided an apparatus and method, which can be used for applying a light-curable composite adhesive to bond materials to a tooth or dental appliance. The composite adhesive is subjected to a controlled application of ultra violet light to cure only a portion of the composite adhesive so that the material is bonded to the tooth or other dental appliance in a desired location. The curing of the portion of the composite adhesive acts to bond the material to the tooth or other dental appliance to the extent where the material is properly secured to the tooth. However, the excess composite adhesive that has been forced from the interface between the material and the tooth is not subjected to the ultra violet light and remains in the uncured flowable condition. The excess composite adhesive is removed from the patient while the composite adhesive is still in a flowable and easily removed condition. Once the excess composite adhesive has been removed an additional application of ultra violet light is made to cure the rest of the composite adhesive to complete the bonding between the material and the tooth. This process significantly reduces the time necessary to remove the excess composite adhesive and greatly reduces the inconvenience to the patient and the dentist. A device is provided that focuses the ultra violet light so that the ultra violet light is presented to the material and the tooth only in the area that the spot bonding is desired. The tool focuses the ultraviolet light without reducing the intensity of the ultra violet lights so that effective curing can take place with the composite adhesive in the desired area. The tool focuses the ultra violet light so that the excess composite adhesive is not subjected to the ultra violet light and remains in the uncured flowable condition.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a front elevation view of the prior art ultra violet light source.

FIG. 2 is a front elevation view of the use of the ultra violet light source of FIG. 1.

FIG. 3 is a front elevation view of the ultra violet light source of the present invention.

FIG. 4 is a front elevation view of the use of the ultra violet light source of FIG. 3.

FIG. 5 is a front elevation view of another feature of the ultra violet light source of the present invention.

FIG. 6 is a partial perspective view of a feature of the invention.

FIG. 7 is a partial perspective view of a feature of the invention.

FIG. 8 is a perspective view showing the use of the invention to spot bond a veneer to a tooth.

FIG. 9 is a perspective view showing the use of the invention to spot bond a crown to a tooth.

### DETAILED DESCRIPTION OF THE PREFERRED EMBODIMENT(S)

The invention is directed to a device and a method for focusing ultra violet light to selectively cure a composite adhesive. More particularly the tool and method are utilized to cure only a portion of the composite adhesive to spot bonding material to a substrate. Other features and advantages of the invention will be more readily understood by referring to the attached drawings in connection with the following description.

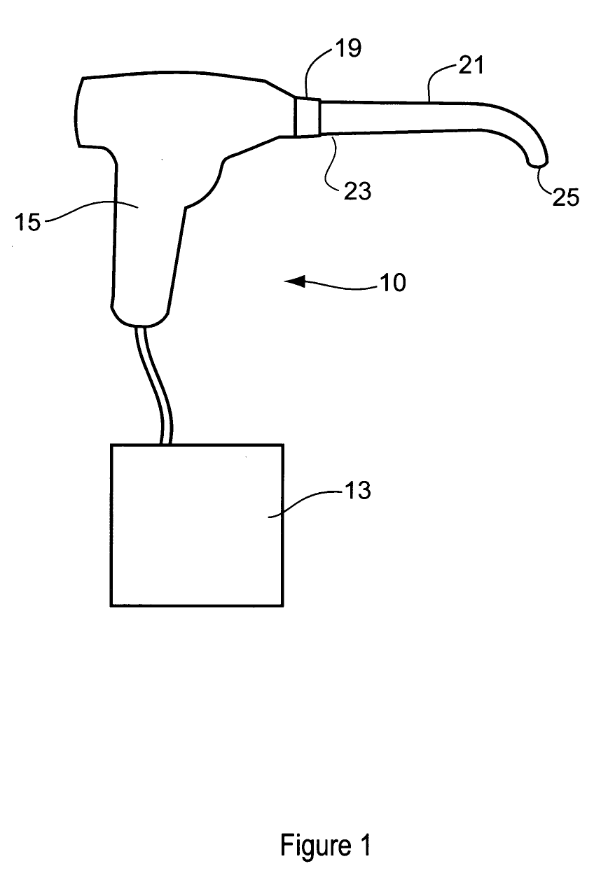

FIG. 1 shows a device 10 that is utilized to generate ultra violet light. The device has a base 13 and a gun 15 that is operatively connected to base 13. The gun 15 is capable of generating a supply of ultra violet light and the ultra violet light is discharged through the nozzle 19 located on the gun 15. A tubular member 21 has a first end 23 that is operatively connected to the nozzle 19. The tubular member 21 has a second end 25 that is spaced apart from the gun 15 and directs the ultra violet light to the desired location. The tubular member 21 can be made from glass or plastic that is suitable for transmitting ultra violet light. Various devices for producing ultra violet light are well known in the industry and examples are produced by Electro-Lite, Coltolux, Global Spec and Exfo. The device 10 can be utilized to cure a composite adhesive Where the adhesive is caused to be cured by the application of ultra violet light. Examples of the composite adhesive are acrylics and epoxies sold by the Electro-Lite Company. The composite adhesives have many uses and are particularly widely used in the dental industry to secure veneers, crowns and other dental appliances to teeth or other substrates used in dentistry.

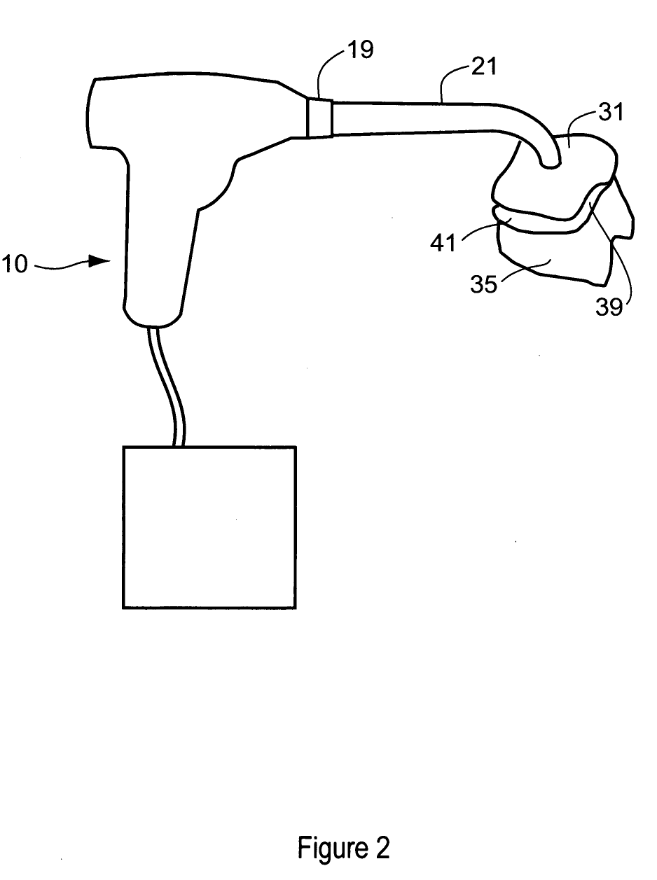

As shown in FIG. 2 there is one example of the utilization of the composite adhesive in the dental industry. In FIG. 2 a veneer 31 is being secured to a tooth 35 through the use of a composite adhesive 39. The composite adhesive 39 is positioned on the tooth 35 and the surface of the veneer 31 that will engage the tooth 35. As shown in FIG. 2 the veneer 31 is positioned on the tooth and forced against the tooth with sufficient pressure whereby at least a portion of the composite adhesive is forced from between the interface between the veneer 31 and the tooth 35. When the veneer 31 is properly positioned the device 10 can be utilized to supply ultra violet light through the nozzle 19 and tubular member 21 to cure the veneer to the surface of the tooth 35. In prior art applications the second end 25 of the tubular member 21 is sufficiently large to provide a source of ultra violet light that cures a significant portion of the composite adhesive 39 that positioned on the veneer 31 and the tooth 35. In fact, the device 10 is used to supply ultra violet to the veneer 31 until essentially all of the composite adhesive 39 is caused to be cured by the ultra violet light. Because a portion of the composite adhesive 39 is forced from the interface between the veneer 31 and the tooth 35 there is excess composite adhesive 41 that is also cured adjacent to the veneer 31. The excess composite adhesive 41 is not intended to be left at the site where the veneer 31 is bonded to the tooth 35. Accordingly, the excess composite adhesive 41 must be removed by the dentist to produce a veneer that has an acceptable appearance and feel to the patient. However, since the composite adhesive has been cured by the ultra violet light from the device 10 the composite adhesive 39 is firmly secured to the surrounding teeth or other dental substrates that might be present. To remove the unwanted cured composite adhesive the dentist must utilize appropriate tools to separate the cured composite adhesive 39 from the unintended areas where the cured excess composite adhesive 41 resides. Picks, drills and grinding wheels are all frequently used to remove the excess composite adhesive, as the cured composite adhesive is very effective at bonding to the surrounding dental surfaces. In many applications an abrasive floss is used to remove excess adhesive from the area between teeth to create the desired margin or space between the teeth. The process of removing the excess cured composite adhesive 41 is very time consuming for the dentist and the patient, and frequently less than a comfortable experience for the patient.

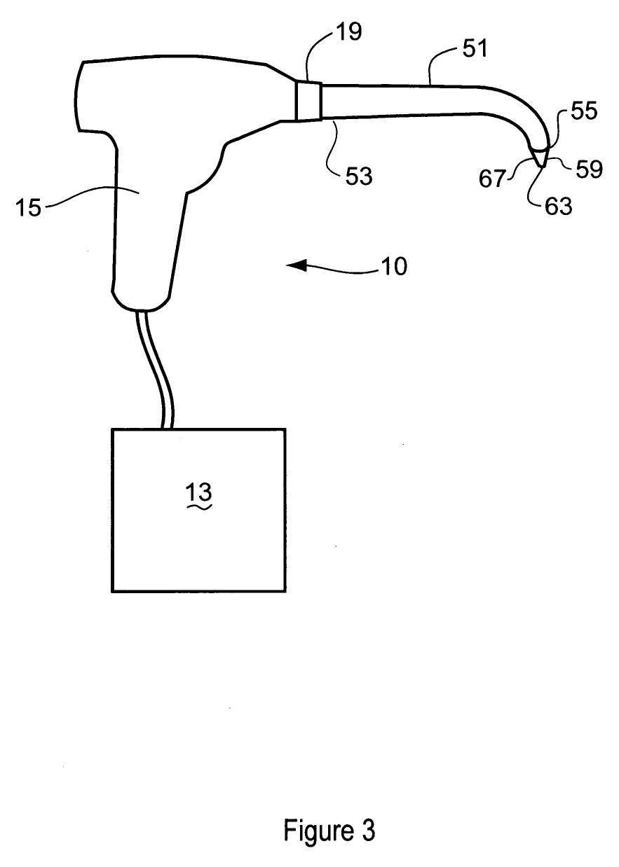

FIG. 3 shows the tool and method of the present invention that has been developed to facilitate the securing of a member to a substrate utilizing a composite adhesive that can be cured through the application of ultra violet light. The invention utilizes the same device 10 to provide a source of ultra violet light. However, the tubular member 51 that is utilized to direct the ultra violet light from the nozzle 19 has been modified. The tubular member 51 has a first end 53 that is positioned in the nozzle 19 as previously described. However, the second end 55 of the tubular member 51 has a reduced diameter section 59 that terminates in a tip 63 that focuses the ultra violet light from the device 10 to a much smaller beam of ultra violet light. The tip 63 has a cross sectional shape that is substantially smaller than the cross section of the tubular member 51. In practice it has been found desirable to have the tip 63 to have a cross sectional area that is from about 10 to about 50 percent of the cross sectional area of the tubular member 51. The tip 63 can have any desired cross sectional shape but it has been found particularly useful with a rectangular, a diamond or an elliptical shape that focuses the ultra violet light from the device 10 into a pattern having a relatively long but narrow configuration. In practice it has been found preferable for the tip 63 to produce a beam of light that forms a pattern that is about 1/64 to about ⅛ of an inch wide and by about ⅛ to about ⅜ of an inch in length.

It is important that the reduced diameter section 59 be configured in a way that the ultra violet light from the device 10 passes from the tubular member 51 to the tip 63 without a significant reduction in intensity of the ultra violet light. Accordingly, the reduced diameter section 59 is usually provided with a dark coating 67 to prevent the ultra violet light from scattering as the ultra violet light is directed or focused into a narrow pattern that is narrower than pattern contained in the tubular member 51.

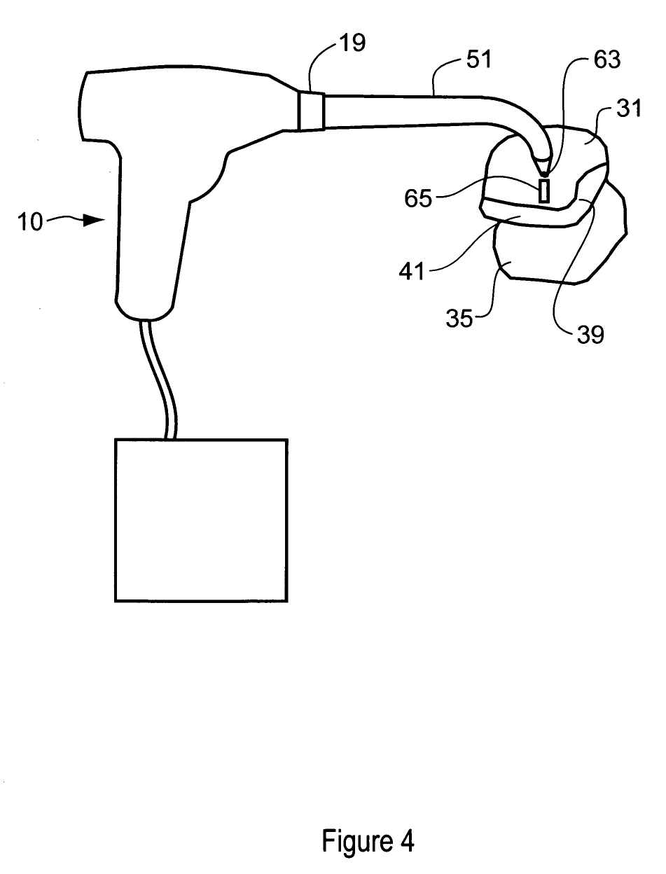

The operation of the invention is shown in FIG. 4. A veneer 31 is positioned on a tooth 35 using composite adhesive 39 in the matter previously described with regard to FIG. 2. There will be excess composite adhesive 41 that is forced from the interface between the veneer 31 and the tooth 35 as previously described. However, in FIG. 4, the ultra violet light from the device 10 is directed at the veneer 31 through the tip 63 whereby a much smaller pattern 65 of ultra violet light is caused to contact the veneer 31. The smaller pattern 65 of ultra violet light is used to cure the composite adhesive 39 in a small area to spot bond the veneer 31 to the tooth 35. The tip 63 is utilized to cure a portion of the composite adhesive 39 that is sufficient to secure the veneer 31 to the tooth 35 so that the veneer cannot be easily moved with respect to tooth 35. Once the veneer 31 has been partially bonded to the tooth 35 the dentist can check to make sure the veneer is properly aligned and that the desired aesthetic result has been accomplished. At the same time the dentist can remove the excess uncured composite adhesive 41 that is on adjacent dental surfaces while the excess composite adhesive is in the uncured and flowable state. The uncured excess composite adhesive is much easier to remove and this can be accomplished by the dentist in a much quicker and less traumatic fashion for the patient. Usually soft material such as dental wipes can be utilized to remove the excess composite adhesive 41. Because the excess composite adhesive can be removed in relatively easy fashion that is less likelihood that a pick, drill, grinding wheel or other tool will come into contact with the area that has been repaired and possibly comprise the aesthetic appearance of the finished result or the quality of the bond created by the cured composite adhesive.

Once the excess composite adhesive has been removed, the dentist can utilize the ultra violet light gun 15 to cure the rest of the composite adhesive in the uncured areas of the interface between the veneer 31 and the tooth 35. The dentist can continue to use the tubular member 51 having the tip 63 to provide the ultra violet light to cure the composite adhesive or the dentist can use the tubular member 21 having the larger surface area of the second end 25 to affect a more rapid cure of the composite adhesive.

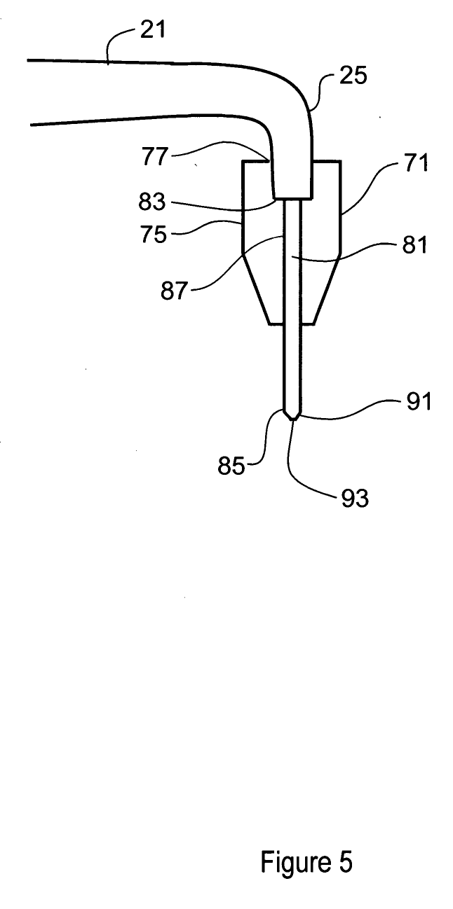

FIG. 5 shows another feature of the present invention where an adaptor 71 is secured to the second end 25 of the tubular member 21 to produce a smaller or more focused beam of ultra violet light that can be used to cure composite adhesives in a manner previously described with regards to FIGS. 3 and 4. The adaptor 71 has a barrel 75 having an opening 77 where the opening 77 is sized to be removeably secured to the second end 25 of the tubular member 21. A rod 81 having a first end 83 and a second end 85 is positioned in a bore 87 in the barrel 75. The bore 87 is in alignment with the opening 77 in the barrel 75 of the adaptor 71. The bore 87 is disposed to be in substantial alignment with the opening 77. The first end 83 of the rod 81 is positioned at the end of the boar 87 that is adjacent the opening 77 in the barrel 75. The first end 83 of the tubular member 81 is disposed to be in contact with the second end 25 of the tubular member 21 when the adaptor 71 is positioned on the tubular member. The rod 81 is formed of a glass or plastic material that is essentially the same as the material that is used to form the tubular member 21. The rod 81 is designed to be an effective and efficient transmitter of ultra violet light that functions in substantially in the same way of the tubular member 21 to direct ultra violet light from the device 10. The first end 83 of the rod 81 and the second end 25 of the tubular member 21 can both have highly polished surfaces to provide an interface that is effective for transmitting the ultra violet light from the tubular member 21 to the rod 81. The rod 81 has a cross sectional area that is substantially smaller than the cross sectional area of the tubular member 21. In most applications the rod 81 is substantially circular in cross section however, it should be understood that other geometric shapes can be used for the rod 81. The second end 85 of the rod 81 extends from the barrel 75 of the adaptor 71 and transmits the ultra violet light from the device 10 to the desired surface or area. The second end 85 can include a converging section 91 that further reduces the cross sectional area of the rod 81 and terminates in a tip 93 that has a cross sectional area that is substantially smaller than the cross sectional area of the rod 81. The converging section 91 can be formed in a way to produce a geometric shape for the tip 93 to produce a pattern of ultra violet light that emerges from the rod 81 that has a desired shape or pattern. The second end 85 or tip 93 is usually highly polished surfaces to provide for a good transfer of ultra violet light from the rod 81 to the surface or area that is to be subjected to the ultra violet light. It has been found desirable to coat the converging section 91 of the second end 85 of the rod 81 with a material that retains the ultra violet light in the rod 81 so that the ultra violet light does not scatter and reduce the intensity of the ultra violet light that emerges from the tip 93. In practice, it has been found desirable to have the tip 93 have a circular, rectangular or elliptical shape. However, it should be understood that other geometric shapes can be used for the tip 93 just as other geometric shapes can used for the rod 81. The ultra violet light that emerges from the second end 85 or tip 83 of the adaptor 71 can used to cure composite adhesives in the manner previously described in this patent application. In particular, the adaptor 71 is useful for spot curing the composite adhesive for dental applications has previously described.

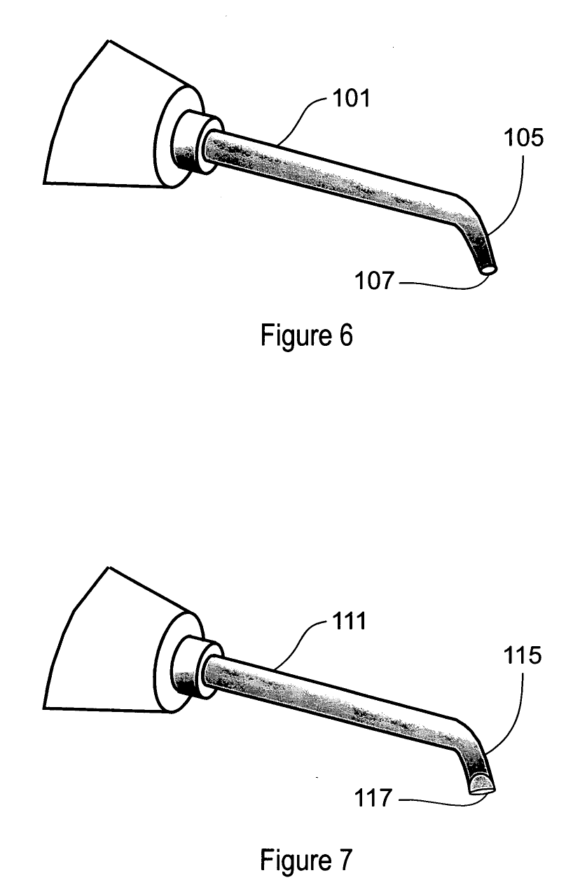

FIG. 6 shows a tubular member 101 that has a second end 105 that terminates in a tip 107 that has a reduced diameter. The tip 107 has a substantially circular cross sectional shape. In FIG. 7 the tubular member 111 has a second end 115 that terminates in a tip 117 having a substantially rectangular cross sectional shape.

The barrel 75 of the adaptor 71 can be made of a flexible or resilient material wherein the barrel and opening 77 can accommodate different size tubular members 21 that supply ultra violet light. The barrel and opening can be stretched to fit over a tubular member and the resilient nature of the barrel will allow a wide variation in the size of tubular members that can be received in the opening 77 and barrel 75. In addition, the opening 77 can be variable in size to accommodate different size tubular members 21. A clamp or ratchet style mechanism can be utilized with the opening 77 to accommodate different size tubular members.

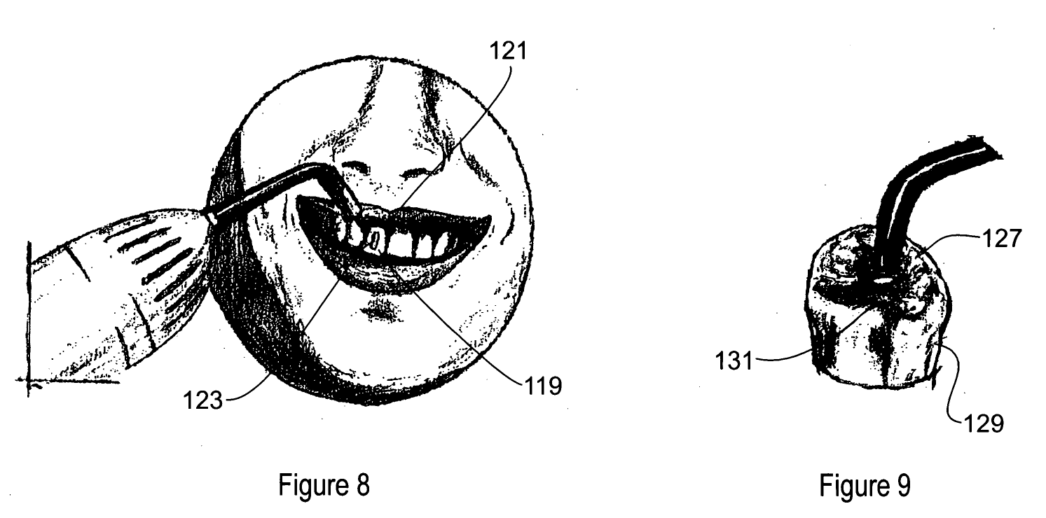

FIG. 7 shows the present invention being used to spot bond a veneer 119 to a tooth 121. A focused pattern of ultra violet light 123 is being directed to spot bond the veneer in the manner previously described. In FIG. 8 the present invention is being used to spot bond a crown 127 to a tooth 129. A focused pattern of ultra violet light 131 is being directed to spot bond the crow to the tooth in the manner previously described.

The above description is given for the sake of explanation of the broad features of the invention. Various modifications and substitutions, other than those referenced, can be made without departing from the scope of the invention as defined by the following claims.

I claim:

1. A device for directing UV light from a UV light source for curing an adhesive composite comprising:
a tubular member having a first end and a second end, the first end being operatively connected to the UV light source;
the second end of the tubular member being spaced apart from the UV light source, the tubular member being constructed to direct the UV light from the UV light source to the second end; and
means for focusing the UV light operatively connected to the second end of the tubular member, the means for focusing the UV light reducing the cross sectional shape of the UV light without substantially reducing the intensity of the UV light.

2. The device of claim 1 wherein the tubular member is formed from glass or plastic that is capable of efficiently transmitting UV light.

3. The device of claim 2 wherein the first and second ends of the tubular member are highly polished to facilitate the transmission of UV light.

4. The device of claim 1 wherein the means for focusing the UV light is a reduced diameter section that decreases the cross sectional area of the tubular member.

5. The device of claim 4 wherein the reduced diameter section has a conical shape and the second end has a circular shape that is smaller in cross section than the tubular member.

6. The device of claim 4 wherein the reduced diameter section conveys to form a generally rectangular shape at the second end.

7. The device of claim 4 wherein the reduced diameter section is coated with a material that retains the UV light in the tubular member whereby the intensity of the UV light at the second end is substantially the same as the intensity of the UV light that enters the first end of the tubular member.

8. The device of claim 1 wherein the means for focusing the UV light is an adaptor that is secured to the second end of the tubular member, the adaptor containing a rod that is suitable for transferring UV light, the rod having a first end that is in contact with the second end of the tubular member for receiving UV light from the tubular member, the rod having a cross that is substantially smaller than the cross section of the tubular member.

9. The device of claim 7 wherein the rod has a second end that extends from the adaptor, the second end being formed in a geometric shape to emit UV light in a desired geometric shape.

10. The device of claim 8 wherein the rod converges towards the second end to form the desired geometric shape for the second end of the rod.

11. The device of claim 9 wherein the rod reduces in cross sectional sizes as the rod forms the desired geometrical shape for the second end of the rod.

12. The device of claim 10 wherein the area where the rod converges to form the smaller cross sectional shape is coated with a material that retains the UV light in the rod whereby the intensity of the UV light at the second end of the rod is substantially the same as the intensity of the UV light that enters the first end of the tubular member.

13. A method for curing an adhesive composite with ultra violet light comprising:
positioning a quantity of the adhesive composite one surface to bond the surface to a substrate;
directing the ultra violet light to a portion of the adhesive composite to cure a portion composite adhesive to spot bond the surface on the substrate;
removing excess adhesive composite from the surface and the substrate, and
subjecting the surface to a second application of ultra-violet light to complete the curing of the composite adhesive to bond the surface to the substrate.

14. The method of claim 10 in which the ultra violet light is focused to cure only a portion of the composite adhesive to spot bond the surface to the substrate.

15. The method of claim 11 in which the composite adhesive is cured to form a spot bond that will secure the member in the substrate so that the member cannot move relative to the substrate.
